(19) United States
(12) Patent Application Publication
(10) Pub. No.: US 2012/0075399 A1
(43) Pub. Date: Mar. 29, 2012

(54) Printing methods and systems

(75) Inventor: Jeffrey E. Polus, Hillsboro, IL (US)

(73) Assignee: THE BOEING COMPANY, Chicago, IL (US)

(21) Appl. No.: 13/270,191

(22) Filed: Oct. 10, 2011

Related U.S. Application Data
(63) Continuation-in-part of application No. 11/112,169, filed on Apr. 22, 2005, now Pat. No. 7,290,911.

(51) Int. Cl. B41J 2/00; B05D 5/00

(52) U.S. Cl. 347/110; 427/256

(57) ABSTRACT

A method for depositing a substance on a real surface of a real object comprises tracking position of an output device on the real surface as the output device is being moved over the real surface. The output device includes a substance-depositing device. The method further comprises using a computer-generated representation of the real surface and extruded surfaces normal to the representation surface at locations where the substance should be deposited; indicating a corresponding tracked position of the output device on the representation surface; and commanding the output device to deposit a substance on the real surface whenever the tracked position on the representation surface crosses an extruded surface.

This is a continuation-in-part of copending U.S. Ser. No. 11/112,169 filed 1 Apr. 2005.

### BACKGROUND

It is quite challenging to transfer images to complex, contoured surfaces that have few defined reference points from which to measure. Images have been mapped onto complex, contoured surfaces using Mylar transfer templates, theodolites, and (more recently) laser projectors. Laser projectors are most accurate, but they are prohibitively expensive.

Moreover, laser projectors do not leave permanent marks on surfaces. In addition, laser projectors do not work effectively in dusty or non-temperature controlled environments, such as environments where machining, painting or coating are performed.

An alternative to laser projectors would be desirable.

### SUMMARY

According to an embodiment herein, a method for depositing a substance on a real surface of a real object comprises tracking position of an output device on the real surface as the output device is being moved over the real surface. The output device includes a substance-depositing device. The method further comprises using a computer-generated representation of the real surface and extruded surfaces normal to the representation surface at locations where the substance should be deposited; indicating a corresponding tracked position of the output device on the representation surface; and commanding the output device to deposit a substance on the real surface whenever the tracked position on the representation surface crosses an extruded surface.

According to another embodiment herein, a method of transferring an image onto a real surface of a real object comprises tracking position of a printing device on the real surface as the printing device is being moved over the real surface; using a CAD model of the object and extruded surfaces normal to a surface of the model at locations where an image should be printed; indicating a corresponding tracked position of the printing device on the surface of the CAD model; and commanding the printing device to print on the real surface whenever the tracked position on the CAD model crosses an extruded surface.

According to another embodiment herein, a system for transferring an image onto a real surface of a real object comprises a substance-depositing engine; a tracking device for tracking position of the substance-depositing engine as the engine is being moved over the real surface; and a computer programmed to use a computer-generated representation of the real surface and extruded surfaces normal to the representation surface at locations where the image should be printed. The representation is used to indicate the tracked position on the representation surface to represent the position of the substance-depositing engine on the real surface, and to command the engine to deposit a substance on the real surface whenever the tracked position on the representation surface crosses an extruded surface.

These features and functions can be achieved independently in various embodiments or may be combined in yet other embodiments further details of which can be seen with reference to the following description and drawings.

### BRIEF DESCRIPTION OF THE DRAWINGS

FIG. 1 is an illustration of a method for depositing a substance on a surface of a real object.

FIGS. 2A and 2B are illustrations of a CAD model having a complex contoured surface.

FIG. 3 is an illustration of a real object that was fabricated from the CAD model.

FIG. 4 is an illustration of tracked positions along a model surface.

FIGS. 5 and 6 are illustrations of systems for depositing a substance on a real surface of a real object.

### DETAILED DESCRIPTION

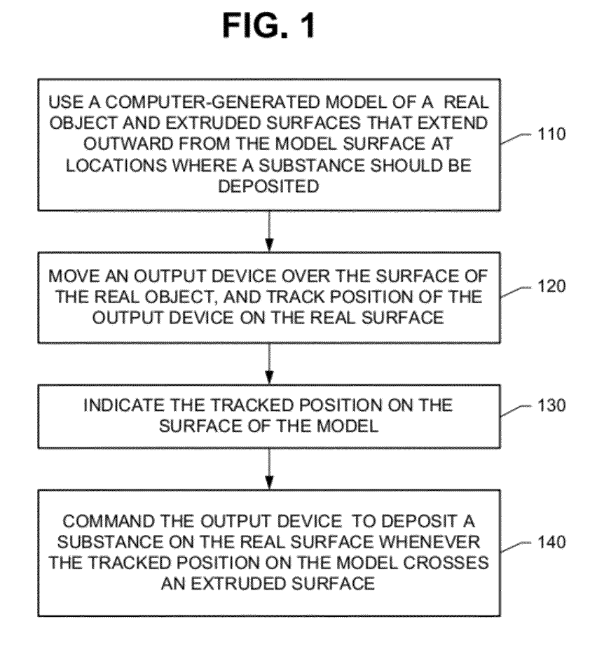

Reference is made to FIG. 1, which illustrates a method for depositing a substance on a real surface of a real object. The real surface may be planar or non-planar. One example of a non-planar surface is a complex contoured surface.

At block 110, a computer-generated representation (e.g., an image or 3D model) of the real surface of the real object is used. The representation may be used, for instance, by running a program on a computer. In some embodiments, a computer-aided design (“CAD”) program is used to access a CAD drawing. The CAD drawing includes a CAD model. In the paragraphs that follow, the representation will be described as a CAD model. However, a method herein is not so limited.

In some embodiments, the CAD model may be used to fabricate the real object. In other embodiments, the CAD model is generated after the real object has been fabricated.

Generally there may be scaling and dimensional differences between the CAD model and the real object. The dimensional differences, or tolerances, may be attributed to the capability of the machine (or human being) that created the real object. These tolerances may also be attributed to the physical make-up of the real object and residual stresses that reside therein due to physical processing (e.g., heating or pressing constituent materials that have dissimilar coefficients of thermal expansion).

To compensate for any tolerances, the CAD model may be correlated to the real object. In some instances, features (e.g., edges, predetermined x-y-z target coordinates) on the real object are correlated to features in the CAD model (e.g., using a best fit method). In other instances, the output of the laser based tracker may be adjusted to account for the tolerances.

The CAD model also indicates locations at which a substance should be deposited.

The CAD drawing also includes extruded surfaces that extend outward from these locations. These extruded surfaces are infinitely thin planes that are normal to the model surface. That is, these extruded surfaces are normal to the surface at locations where the substance should be deposited. Most CAD programs have tools for generating the extruded surfaces. The extruded surfaces may be represented within a CAD drawing in any number of forms (e.g., ruled surfaces, sheet surfaces).

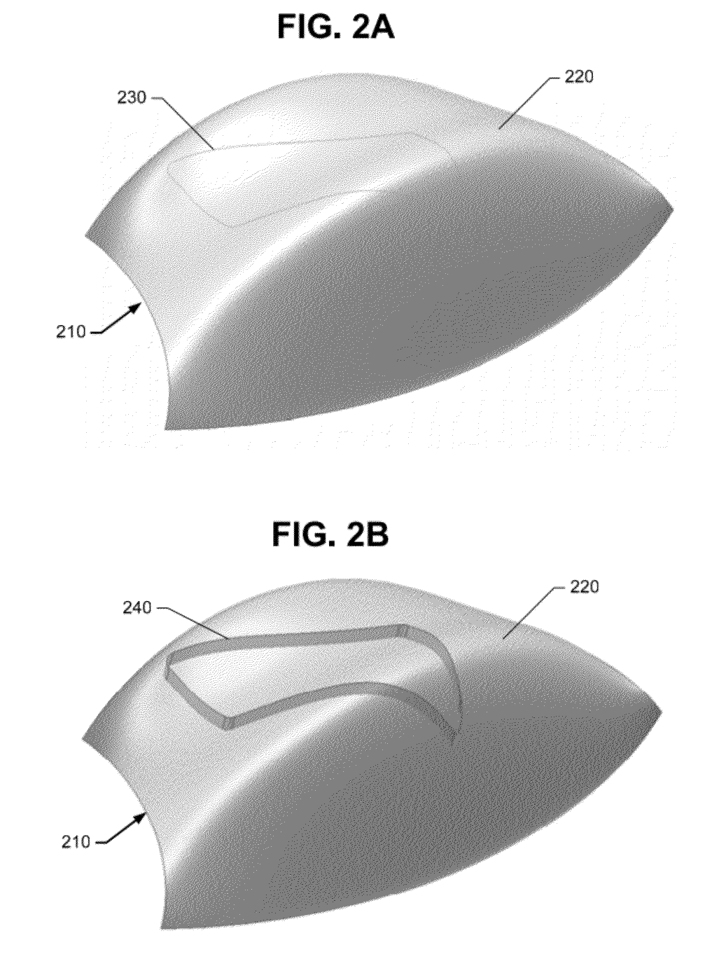

Additional reference is made to FIGS. 2A and 2B, which illustrate a CAD model 210 having a complex contoured surface 220. FIG. 2A also illustrates an outline 230 of an access panel. FIG. 2B illustrates extruded surfaces 240 at the outline of the access panel 230.

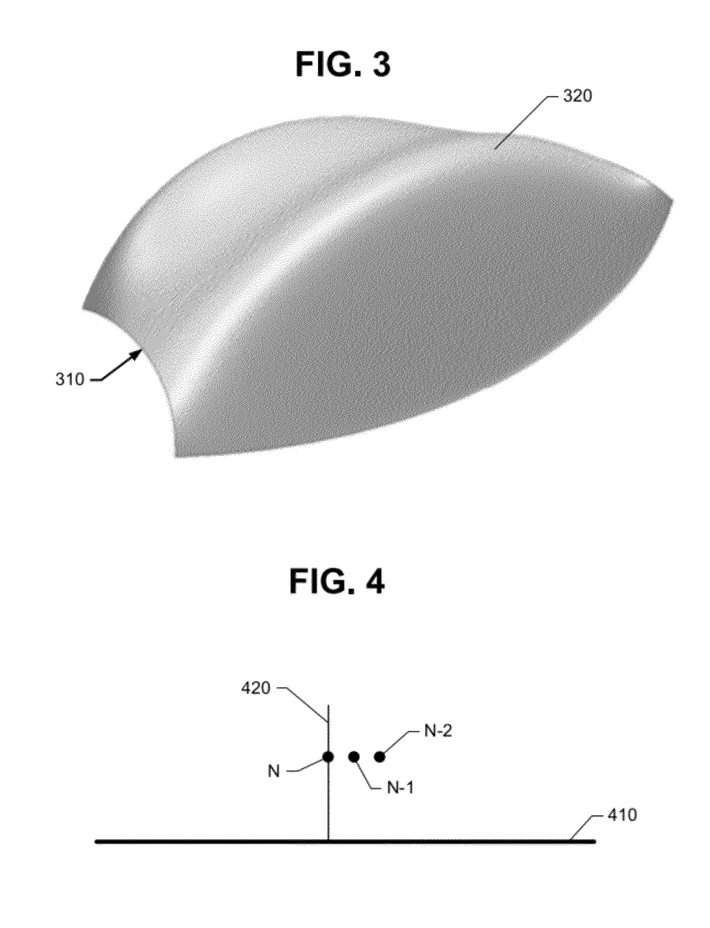

Reference is now made to FIG. 3, which illustrates a real object 310 that was fabricated from the CAD model. The real object 310 has a complex contoured surface 320 without any markings.

Reference is once again made to FIG. 1. At block 120, an output device is moved over the real surface of the real object. The output device may be in physical contact with the real surface. The output device includes a substance-depositing device, which is remotely actuated to deposit the substance. Examples of the substance include, but are not limited to, ink, paint, ceramics, silicone, polyurethane, conductive powder (e.g., gold, silver, copper, and carbon), nanoparticles, proteins, and enzymes.

In some embodiments, the output device may be moved manually. In other embodiments, the output device may be moved by a positioning system such as a robot or gantry.

The output device may be moved in a pattern, or it may be moved randomly. The output device may be moved over the entire surface of the real object, or it may be moved only over portions where the substance should be deposited.

As the output device is being moved over the real surface of the real object, its position on the real surface is being tracked. The tracking is performed in real time. The tracking may be performed by a laser tracker.

At block 130, the tracked position is indicated on the surface of the CAD model. The tracking is performed in real time, and the position on the model surface is updated in real time.

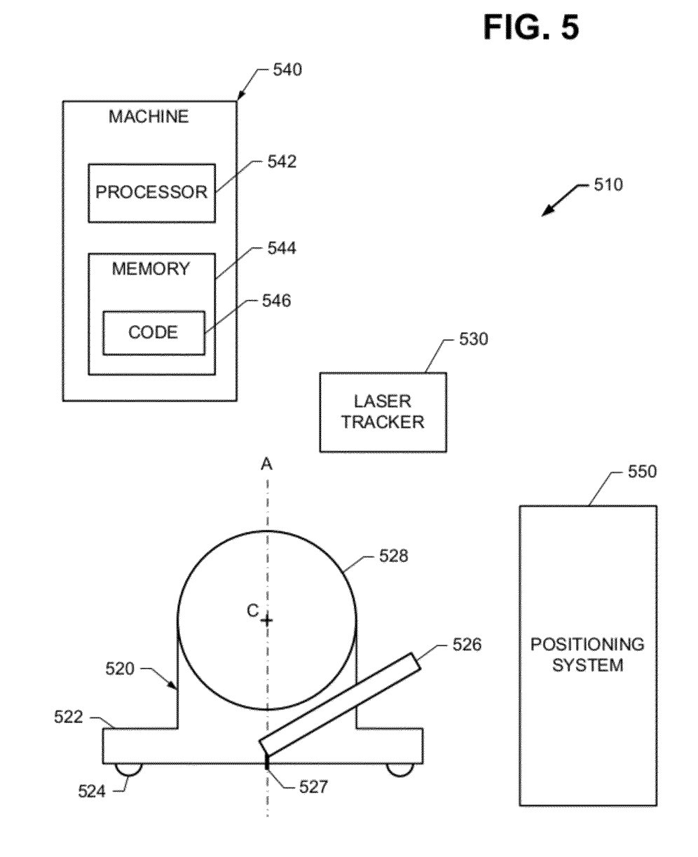

At block 140, the output device is commanded to deposit a substance on the real surface of the real object whenever the tracked position on the model surface crosses an extruded surface (see FIG. 4, which illustrates the tracked positions N-2, N-1 and N along a model surface 410, and which further illustrates the N^{th} position crossing an extruded surface 420). The output device may be commanded to deposit a dot, line or other shape whenever its tracked position crosses an extruded surface.

Consider the example of the real object 310 of FIG. 3. The real object 310 was fabricated from the CAD model 210 of FIG. 2A, without the outline on the surface 320. Using the method of FIG. 1 and the CAD drawings of FIG. 2B, an output device can print the outline of the access door on the surface 320 of the real object 310. Afterwards, an access door opening may be cut into the real object 310.

A method herein may be used to deposit a substance at precise locations on a real surface. The precision is achieved without using an expensive device such as a laser projector or theodolite. Instead, a relatively inexpensive device such as a laser tracker may be used.

Unlike laser projection, a method herein is effective in dusty or non-temperature controlled environments, such as environments where machining, painting or coating are performed. Moreover, a method herein may leave permanent markings on the surface. In contrast, a laser projector only shines laser generated curves and lines on the surface of a part. Those lines and curves disappear if the laser projector is turned off or if the part is moved out of range of the laser projector.

A method herein does not require specific programming queues to initiate the marking on the surface. A print pattern or deposition pattern may be changed simply by modifying extruded surfaces with respect to the model surface. A method herein also takes into account the surface differences between the model (that is, the part “as designed”) and the real object (that is, the part “as built”).

A method herein may be used to print indicia and other images on contoured surfaces, such as surfaces of full-scale aircraft, automobiles, and marine vehicles. The method may also be used to print designs on relatively planar surfaces provided by objects such as signs and billboards. Other examples include, without limitation, depositing material onto solar panel substrates, and thermal protection coatings onto rockets or missiles.

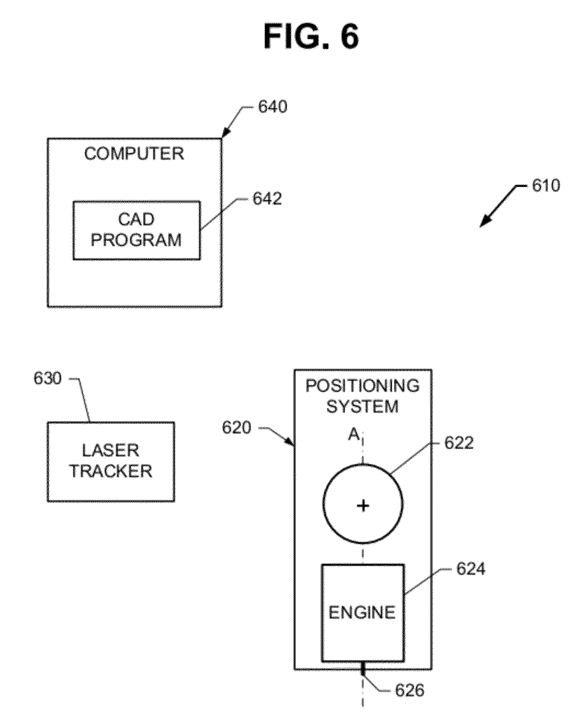

Reference is made to FIG. 5, which illustrates an example of a system 510 for performing a method herein. The system 510 includes an output device 520 that is configured for laser tracking. The output device 520 includes a base 522 supported by feet or rollers 524. The base 522 and rollers 524 are configured to slide across a surface of a real object.

The output device 520 further includes a substance-depositing engine 526 that is supported by the base 522. The engine 526 may have only a single nozzle or it may have an array of nozzles. The embodiment of FIG. 5 has a single nozzle 527 extending out of the base 522 and directed downward. In some embodiments, the substance-depositing engine 526 may include an inkjet print engine. The engine 526 further includes an interface for receiving commands that instruct the nozzle 527 to fire and deposit the substance.

In some embodiments, the base 522 is small enough relative to the real surface contour to keep the nozzle 527 normal to the real surface of the real object. In other embodiments, the output device 520 may be kept at a constant parallel offset distance from the real surface via a robotic arm, thereby avoiding contact with the real surface.

The output device 520 further includes a reflector ball 528, which rests upon the base 522. The reflector ball's center point (C) is aligned with the nozzle 527 along a tracking axis (A). The center point (C) may be tracked in a CAD program.

The system 510 further includes a laser tracker 530. During operation, the laser tracker 530 directs a laser beam towards the reflector ball 528, and detects a return signal (which is reflected off the reflector ball 528). From the return signal, the laser tracker 530 can determine distance to the center point (C) and angular position of the center point (C) of the tracking ball 528.

The system 510 further includes a computer 540 including a processor 542 and memory 544. Stored in the memory 544 is code 546 that, when executed, accesses a file of a computer-generated representation of the real object and extruded surfaces. For example, the code 546 may include a CAD program that displays a 3D model of the real object and also the extruded surfaces. The CAD program takes the distance and angle from the laser tracker 530 and indicates the center position on the surface of the CAD model. This position corresponds to the actual position of the reflector ball's center position (C) on the real surface of the real object. Whenever, the center position crosses an extruded surface, the CAD program commands the nozzle 527 to fire.

The type of CAD program will depend upon the type of real object. Examples of CAD programs include, but are not limited to, architectural design programs, electronics design programs, roadway design programs, woven fabric design programs, and mechanical design programs.

The code 546 is not limited to a CAD program. The code 546 may include any program that can perform the functions above. For instance, the code 546 may include a program that utilizes IGES files (IGES is a file format that defines a vendor neutral data format that allows the digital exchange of information among CAD systems) and that processes data from a laser tracker.

In some embodiments, the output device 520 may be moved manually over the surface of the real object. In other embodiments, the output device 520 may be moved by a positioning system 550. For instance, a robot or gantry may be used to move the output device 520 over the complex contoured surface of an aircraft. A tractor may be used to move the output device 520 over a lawn (e.g., to transfer ground art). A robot may be used to move the output device 520 over a billboard.

Reference is made to FIG. 6, which illustrates another example of a system 610 for performing a method herein. In this example, a positioning system 620 such as a robot or a gantry may be adapted to perform the method herein. A reflector ball 622 and substance-depositing engine 624 may be added to an end effector of a robot. A reflector ball 622 and substance-depositing engine 624 may be added to the end of an arm, cantilevered beam or stylus of a gantry.

The type of end effector is application-specific. For example, an end effector for painting commercial aircraft may include a paint spray head.

As the positioning system 620 scans across a surface of an object, a laser tracker 630 tracks the center (C) of the reflector ball 622. A computer 640 running a CAD program 642 accesses a CAD model of the object and may indicate the tracked position on the CAD model. In the alternative, the laser tracker 630 or CAD program 642 may use an offset from the reflector ball center (C) to the engine's nozzle 626 to track the nozzle position.

1. A method for depositing a substance on a real surface of a real object, the method comprising:
tracking position of an output device on the real surface as the output device is being moved over the real surface, the output device including a substance-depositing device;
using a computer-generated representation of the real surface and extruded surfaces normal to the representation surface at locations where the substance should be deposited;
indicating a corresponding tracked position of the output device on the representation surface; and
commanding the output device to deposit a substance on the real surface whenever the tracked position on the representation surface crosses an extruded surface.

2. The method of claim 1, wherein the real surface is a complex contour surface.

3. The method of clam 1, wherein the output device is in physical contact with the real surface during movement over the real surface.

4. The method of claim 1, wherein the tracking is performed in real time and wherein the tracked position on the representation surface is updated in real time.

5. The method of claim 1, wherein using the computer-generated representation includes running a CAD program, the CAD program indicating the tracked position on the surface of a CAD model.

6. The method of claim 1, wherein the output device is tracked with a laser tracker; and wherein the laser tracker determines relative distance to the output device and relative angle of the output device.

7. The method of claim 1, wherein the output device includes a print engine, wherein the locations in the representations correspond to an image; and wherein the output device is commanded to print the image on the real surface.

8. The method of claim 1, further comprising correlating features on the representation to features on the real object to account for any tolerances between the representation and the real object.

9. The method of claim 1, further comprising using a positioning system to position the output device; and wherein the output device includes a reflector and a substance-depositing engine that are integrated with the positioning system.

10. The method of claim 1, wherein the deposited substance leaves permanent markings on the real surface.

11. The method of claim 1, wherein the real object is located in at least one of a dusty environment and a non-temperature controlled environment.

12. A method of transferring an image onto a real surface of a real object, the method comprising:
tracking position of a printing device on the real surface as the printing device is being moved over the real surface;
using a CAD model of the object and extruded surfaces normal to a surface of the model at locations where the image should be printed;
indicating a corresponding tracked position of the printing device on the surface of the CAD model; and
commanding the printing device to print on the real surface whenever the tracked position on the CAD model crosses an extruded surface.

13. A system for transferring an image onto a real surface of a real object, the system comprising:
a substance-depositing engine;
a tracking device for tracking position of the substance-depositing engine as the engine is being moved over the real surface; and
a computer programmed to use a computer-generated representation of the real surface, and extruded surfaces normal to the representation surface at locations where the image should be printed, wherein the representation is used to indicate the tracked position on the representation surface to represent the position of the substance-depositing engine on the real surface, and to command the engine to deposit a substance on the real surface whenever the tracked position on the representation surface crosses an extruded surface.

14. The system of claim 13, wherein the tracking is performed in real time and wherein the tracked position on the representation surface is updated in real time.

15. The system of claim 13, wherein the computer-generated representation includes a CAD model.

16. The system of claim 13, wherein the tracking device includes a laser tracker, and wherein a laser reflector is aligned with the engine.

17. The system of claim 16, further comprising a positioning system including one of a gantry and robot; wherein the reflector and the engine are mounted to the positioning system.

18. The system of claim 17, wherein the positioning device includes an end effector; and wherein the engine and the reflector are mounted to the end effector.

19. The system of claim 13, wherein the locations in the representation correspond to an image; and wherein the engine is commanded to print the image on the real surface.

20. The system of claim 13, wherein the deposited substance leaves permanent markings on the real surface.
